(19) United States
(12) Patent Application Publication
(10) Pub. No.: US 2005/0226615 A1
(43) Pub. Date: Oct. 13, 2005

(54) Phase-encoded optical code division multiple access

(75) Inventors: Peter Chu, Torrance, CA (US); Grant S. Williams, El Segundo, CA (US); Joshua A. Conway, Redondo Beach, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: THE BOEING COMPANY

(21) Appl. No.: 10/818,085

(22) Filed: Apr. 5, 2004

(51) Int. Cl. H04J 4/00

(52) U.S. Cl. 398/78; 398/1

(57) ABSTRACT

A system and method for performing phase-encoded optical Code Division Multiple Access (CDMA). A transmitter encodes digital data onto a wavelength of an optical signal using a codeword, splits the optical signal into a plurality of beams having separated frequency components, selectively phase-shifts the beams in accordance with the codeword, recombines the beams into the optical signal, and transmits the optical signal. The receiver receives the optical signal, splits the optical signal into a plurality of beams having separated frequency components, selectively phase-shifts the beams in accordance with the codeword, recombining the beams into the optical signal, and decodes the digital data from a wavelength of the optical signal using the codeword.

### BACKGROUND OF THE INVENTION

1. Field of the Invention

The present invention relates to systems and methods for optical data communications, and in particular to a system and method for phase-encoded optical code division multiple access (CDMA) communications.

2. Description of the Related Art

In recent years, Spread Spectrum-Multiple Access (SS-MA) techniques have led to a revolution in communications. SS-MA allows multiple users to share the same bandwidth. Since a single user requires only a slight fraction of the total available bandwidth, the remaining bandwidth can be distributed among the other users in the area.

Code Division Multiple Access (CDMA) is one implementation of SS-MA. CDMA allows a large number of users to be served by reusing its allocated frequency band. In CDMA, a single user is not confined to a single frequency, and can transmit anywhere in the allocated frequency band at a given time. A codeword is assigned to each user, which allows the interference from other users to be filtered out by the receiver. As a result, CDMA provides a level of resistance to eavesdropping.

Optical CDMA is an attractive way of exploiting the exceedingly high bandwidths available at optical frequencies. Usually, a single user will not need the throughput available on optical communications systems, which can reach as high as 40 Gbps. Also, the added layer of protection from eavesdropping provided by CDMA is attractive. Optical CDMA will allow many users to share the same carrier signal, while not requiring that user to use all of the available bandwidth of that carrier signal, a problem which is not yet solved effectively.

The present invention is novel implementation of optical CDMA. Most prior art implementations of optical CDMA use either time encoding or wavelength encoding. In the present invention, however, encoding is performed both on the phase as well as the wavelength of the optical signal.

### SUMMARY OF THE INVENTION

To address the requirements described above, the present invention discloses a system and method for performing phase-encoded optical Code Division Multiple Access (CDMA).

The system includes a transmitter for encoding digital data onto a wavelength of an optical signal using a codeword, for splitting the optical signal into a plurality of beams having separated frequency components, for selectively phase-shifting the beams in accordance with the codeword, for recombining the beams into the optical signal, and for transmitting the optical signal.

The system also includes a receiver for receiving the optical signal, for splitting the optical signal into a plurality of beams having separated frequency components, for selectively phase-shifting the beams in accordance with the codeword, for recombining the beams into the optical signal, and for decoding the digital data from a wavelength of the optical signal using the codeword.

Phase-encoding occurs when non-phase-shifted beams are phase-shifted at the transmitter in order to generate a phase-shifted optical signal. Phase-decoding occurs when phase-shifted beams are phase-shifted at the receiver in order to generate a non-phase-shifted optical signal. The non-phase-shifted optical signal is used at the receiver to decode the digital data.

The phase-shifting is performed in both the transmitter and the receiver using one or more Fiber Bragg Grating (FBG) filters. Each of the filters has its grating spacing such that delays incurred by the beams result in a phase-shift of either 0° or 180°.

### BRIEF DESCRIPTION OF THE DRAWINGS

Referring now to the drawings in which like reference numbers represent corresponding parts throughout:

FIG. 1 is a block diagram that illustrates an optical CDMA system according to a preferred embodiment of the present invention;

FIG. 2 is a block diagram that illustrates a wavelength and phase encoder according to a preferred embodiment of the present invention; and

FIG. 3 is a block diagram that illustrates a wavelength and phase decoder according to a preferred embodiment of the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

System Description

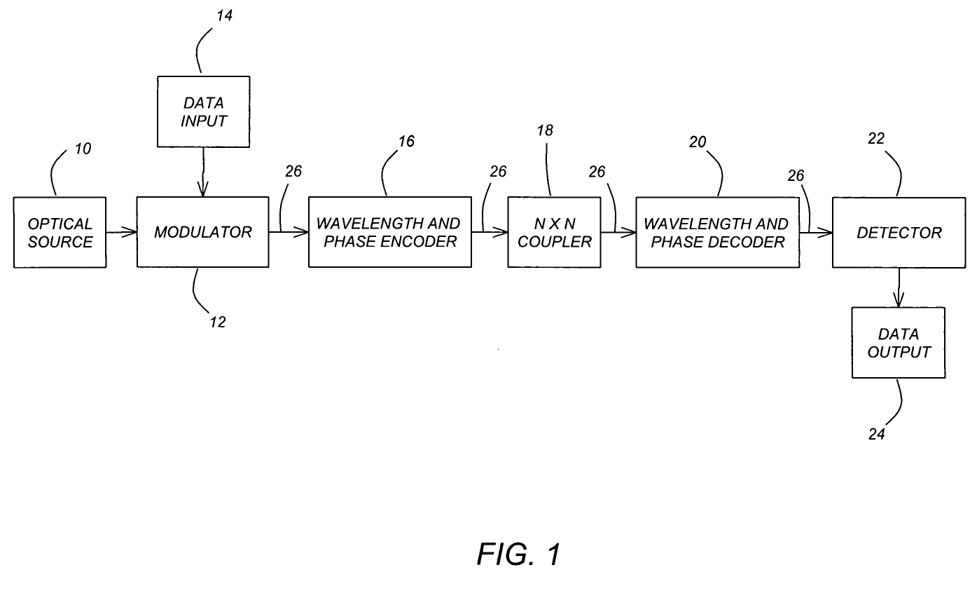

FIG. 1 is a block diagram that illustrates an optical CDMA system according to a preferred embodiment of the present invention. The system is comprised of transmitter comprising an optical source 10, an optical modulator 12 that accepts digital data input 14 and a wavelength and phase encoder 16, an N×N coupler 18 that couples the transmitter to the receiver, and a receiver that comprises a wavelength and phase decoder 20 and a detector 22 that generates digital data output 24. The optical fiber 26 in the system preferably comprises polarization maintaining (PM) fiber 26.

The optical source 10 preferably is a broadband laser source. The bandwidth of the optical source 10 may range from a few nanometers in width to 100 nanometers or more. This bandwidth is needed to accommodate the wavelength encoding that is performed for the CDMA implementation.

The optical modulator 12 preferably is an amplitude modulator, such as an On-Off Keying (OOK) modulator. The digital data input 14 is a unipolar data sequence (e.g., 1100) that is modulated by the modulator 12 using a unipolar codeword uniquely associated with the user (e.g., 1,0,0,1), onto the optical signal output from the optical source 10. The modulation of the digital data input 14 by the codeword spreads the spectrum of the original user signal over the available optical bandwidth.

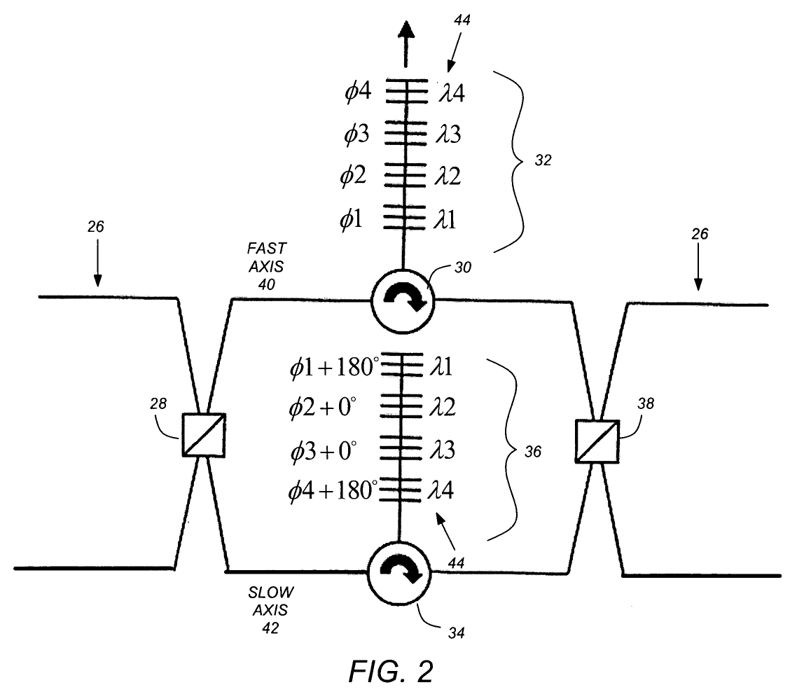

The optical modulator 12 is followed by a wavelength and phase encoder 16, which is described by the block diagram of FIG. 2. The wavelength and phase encoder 16 includes a polarizing splitter 28, upper circulator 30, upper filter arm 32, lower circulator 34, lower filter arm 36 and polarization combiner 38.

The polarizing splitter 28 takes the optical signal and splits it into two separate paths containing equal power, i.e., one in the fast axis 40 of the wavelength and phase encoder 16 to the upper circulator 30, and another in the slow axis 42 of the wavelength and phase encoder 16 to the lower circulator 34. The upper circulator 30 feeds the optical signal on the fast axis 40 into the upper filter arm 32, while the lower circulator 34 feeds the optical signal on the slow axis 42 into the lower filter arm 36.

Each filter arm 32, 36 is comprised of a sequence of one or more Fiber Bragg Grating (FBG) filters 44. These filters 44 receive the optical signal and generate a dispersed beam having separated frequency components.

The FBG filters 44 on the upper filter arm 32 are constructed so that the first wavelength reflected is λ₁, the second wavelength reflected is λ₂, and so on, for n wavelengths being encoded. In the example of FIG. 2, n=4, although any number of wavelengths could be used. All wavelengths being emitted by the optical source 10 that are not being encoded will pass by the FBG filters 44, and no longer be dealt with on this end of the system.

Each FBG filter 44 in the upper filter arm 32 has its grating spacing such that the no phase-shifts are incurred by the signals on the upper filter arm 32. In the example of FIG. 2, the FBG filters 44 labeled as λ₁, λ₂, λ₃ and λ₄ on the upper filter arm 32 impose no phase-shift as indicated by the labels φ1+0°, φ2+0°, φ3+0° and φ4+0°.

The FBG filters 44 of the lower filter arm 36 perform the phase encoding. The FBG filters 44 on the lower filter arm 36 are constructed so that the first wavelength reflected is λ₄, the second wavelength reflected is λ₃, and so on. This is so any temporal dispersion due to differing path lengths traversed in the FBG filters 44 can be corrected at the receiver.

Each FBG filter 44 in the lower filter arm 36 has its grating spacing increased such that the delays incurred by the signals on the lower filter arm 36 result in a phase-shift of either 0° or 180° from the upper filter arm 32. In the example of FIG. 2, the FBG filters 44 labeled as λ₁ and λ₄ on the lower filter arm 36 perform a 180° phase-shift as indicated by the labels φ1+180° and φ4+180°, while the FBG filters 44 labeled as λ₂ and λ₃ perform no phase-shift as indicated by the labels φ2+0° and φ3+0°. These phase-shifts correspond to a codeword of (1,0,0,1).

The upper circulator 30 feeds the optical signal from the upper filter arm 32 onto the fast axis 40 of the wavelength and phase encoder 16, while the lower circulator 34 feeds the optical signal from the lower filter arm 36 onto the slow axis 42 of the wavelength and phase encoder 16. The signals from the fast and slow axes 40, 42 of the wavelength and phase encoder 16 are then recombined by the polarization combiner 38 and output from the wavelength and phase encoder 16.

After being output from the transmitter, the signals are transmitted by fiber 26 to the N×N coupler 18, where they are mixed with other signals, and then transmitted by fiber 26 to any number of different receivers.

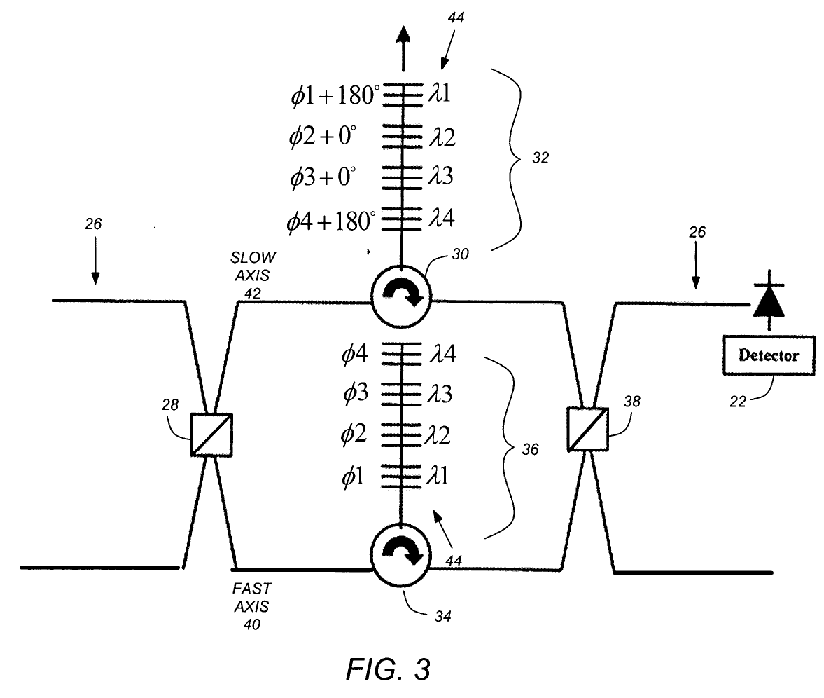

At a receiver, the signals are decoded by a wavelength and phase decoder 20, which is described by the block diagram of FIG. 3. The wavelength and phase decoder 20 at the receiver is a near mirror image of the wavelength and phase encoder 16, and includes a polarizing splitter 28, upper circulator 30, upper filter arm 32, lower circulator 34, lower filter arm 36, coupler 46 and detector 22.

The polarizing splitter 28 takes the optical signal and splits it into two separate paths containing equal power, i.e., one in the fast axis 40 of the wavelength and phase decoder 20 to the lower filter arm 36, and another in the slow axis 42 of the wavelength and phase decoder 20 to the upper filter arm 32. The upper circulator 30 feeds the phase-shifted optical signal on the slow axis 42 into the upper filter arm 32, while the lower circulator 34 feeds the non-phase-shifted optical signal on the fast axis 40 into the lower filter arm 36.

As with the wavelength and phase encoder 16, each filter arm 32, 36 is comprised of a sequence of one or more FBG filters 44. These filters 44 receive the optical signal and generate a dispersed beam having separated frequency components.

The phase-shifted optical signal passes through an array of FBG filters 44 in the upper filter arm 32 identical to the FBG filters 44 present in the lower filter arm 36 of the wavelength and phase encoder 16, and the non-phase-shifted optical signal passes through an array of FBG filters 44 in the lower filter arm 36 identical to the FBG filters 44 present in the upper filter arm 32 of the wavelength and phase encoder 16. Thus, all temporal and phase differences due to the FBG filters 44 are eliminated. Also, any other wavelengths used by other channels (e.g. λ₅, λ₆ and so on) are not reflected by the FBG filters 44, and so are eliminated here.

The upper circulator 30 feeds the optical signal from the upper filter arm 32 onto the slow axis 42 of the wavelength and phase decoder 20, while the lower circulator 34 feeds the optical signal from the lower filter arm 36 onto the fast axis 40 of the wavelength and phase decoder 20.

The signals from the fast and slow axes 40, 42 of the wavelength and phase decoder 20 are then recombined by the polarization combiner 38. However, only signals that are in phase will appear at the output of the polarization combiner 38 and be input to the detector 22. Therefore, in this example, since the signal incident has the (1,0,0,1) codeword imparted on it, all four signals will add constructively, and a strong signal will pass through to the detector 22.

The optical detector 22 detects the intensity of the optical signal received from the wavelength and phase decoder 20, and demodulates the digital data output 24 from the optical signal. As above, the digital data output 24 is a unipolar data sequence (e.g., 1100) that is demodulated by the detector 22 using a unipolar codeword uniquely associated with the user (e.g., 1,0,0,1), from the optical signal output from the wavelength and phase decoder 20.

Preferably, optical signals for other users are phase-shifted using another codeword that is orthogonal to the (1,0,0,1) codeword, such as (0,1,1,0), so that the optical signals for other users add destructively to the optical signal, and no light will pass through the output. However, optical signals for other users may be phase-shifted using another codeword that is non-orthogonal to the codeword, so that the optical signals for other users add constructively to the optical signal as noise. This is one of the unavoidable downsides of CDMA, i.e., other users act as noise to every other user.

### CONCLUSION

This concludes the description of the preferred embodiment of the invention. The following paragraphs describe some alternative embodiments for accomplishing the same invention.

In alternative embodiments, codewords of any length may be used. In addition, any number of filters may be used and thus the dispersed beam may have any number of separated frequency components. Moreover, the amount and degree of phase-shifts performed by the filters may differ from those described herein.

In summary, the present invention discloses a system and method for performing phase-encoded optical Code Division Multiple Access (CDMA). Digital data is encoded by a transmitter onto a wavelength of an optical signal using a codeword, the optical signal is split into a plurality of beams having separated frequency components, the beams are selectively phase-shifted in accordance with the codeword, the beams are then recombined into the optical signal, which is transmitted to a receiver. The optical signal is received by the receiver, the optical signal is split into a plurality of beams having separated frequency components, the beams are selectively phase-shifted in accordance with the codeword, the beams are recombined into the optical signal, and the digital data is decoded from a wavelength of the optical signal using the codeword.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A system for performing phase-encoded optical Code Division Multiple Access (CDMA), comprising:
a transmitter for encoding digital data onto a wavelength of an optical signal using a codeword, for splitting the optical signal into a plurality of beams having separated frequency components, for selectively phase-shifting the beams in accordance with the codeword, for recombining the beams into the optical signal, and for transmitting the optical signal; and
a receiver for receiving the optical signal, for splitting the optical signal into a plurality of beams having separated frequency components, for selectively phase-shifting the beams in accordance with the codeword, for recombining the beams into the optical signal, and for decoding the digital data from a wavelength of the optical signal using the codeword.

2. The system of claim 1, wherein the phase-shifting is performed using one or more filters.

3. The system of claim 2, wherein the filters are Fiber Bragg Grating (FBG) filters.

4. The system of claim 2, wherein each of the filters has its grating spacing such that delays incurred by the beams result in a phase-shift of either 0° or 180°.

5. The system of claim 1, wherein non-phase-shifted beams are phase-shifted at the transmitter in order to generate a phase-shifted optical signal.

6. The system of claim 1, wherein phase-shifted beams are phase-shifted at the receiver in order to generate a non-phase-shifted optical signal.

7. The system of claim 6, wherein the non-phase-shifted optical signal is used at the receiver to decode the digital data.

8. The system of claim 1, wherein optical signals for other users are phase-shifted using another codeword that is orthogonal to the codeword, so that the optical signals for other users add destructively to the optical signal.

9. The system of claim 1, wherein optical signals for other users are phase-shifted using another codeword that is non-orthogonal to the codeword, so that the optical signals for other users add constructively to the optical signal as noise.

10. A method for performing phase-encoded optical Code Division Multiple Access (CDMA), comprising:
encoding digital data onto a wavelength of an optical signal using a codeword at a transmitter;
splitting the optical signal into a plurality of beams having separated frequency components;
selectively phase-shifting the beams in accordance with the codeword;
recombining the beams into the optical signal;
transmitting the optical signal to a receiver;
receiving the optical signal at the receiver;
splitting the optical signal into a plurality of beams having separated frequency components;
selectively phase-shifting the beams in accordance with the codeword;
recombining the beams into the optical signal; and
decoding the digital data from a wavelength of the optical signal using the codeword at the receiver.

11. The method of claim 10, wherein the phase-shifting is performed using one or more filters.

12. The method of claim 11, wherein the filters are Fiber Bragg Grating (FBG) filters.

13. The method of claim 11, wherein each of the filters has its grating spacing such that delays incurred by the beams result in a phase-shift of either 0° or 180°.

14. The method of claim 10, wherein non-phase-shifted beams are phase-shifted at the transmitter in order to generate a phase-shifted optical signal.

15. The method of claim 10, wherein phase-shifted beams are phase-shifted at the receiver in order to generate a non-phase-shifted optical signal.

16. The method of claim 15, wherein the non-phase-shifted optical signal is used at the receiver to decode the digital data.

17. The method of claim 10, wherein optical signals for other users are phase-shifted using another codeword that is orthogonal to the codeword, so that the optical signals for other users add destructively to the optical signal.

18. The method of claim 10, wherein optical signals for other users are phase-shifted using another codeword that is non-orthogonal to the codeword, so that the optical signals for other users add constructively to the optical signal as noise.

19. A transmitter for a phase-encoded optical Code Division Multiple Access (CDMA) communications system, comprising:
a transmitter for transmitting an optical signal to a receiver;
wherein the transmitter encodes digital data onto a wavelength of the optical signal using a codeword, splits the optical signal into a plurality of beams having separated frequency components, selectively phase-shifts the beams in accordance with the codeword, recombines the beams into the optical signal, and transmits the optical signal to the receiver; and
wherein the receiver receives the optical signal from the transmitter, splits the optical signal into a plurality of beams having separated frequency components, selectively phase-shifts the beams in accordance with the codeword, recombines the beams into the optical signal, and decodes the digital data from a wavelength of the optical signal using the codeword.

20. A receiver for a phase-encoded optical Code Division Multiple Access (CDMA) communications system, comprising:
a receiver for receiving an optical signal from a receiver;
wherein the transmitter encodes digital data onto a wavelength of the optical signal using a codeword, splits the optical signal into a plurality of beams having separated frequency components, selectively phase-shifts the beams in accordance with the codeword, recombines the beams into the optical signal, and transmits the optical signal to the receiver; and
wherein the receiver receives the optical signal from the transmitter, splits the optical signal into a plurality of beams having separated frequency components, selectively phase-shifts the beams in accordance with the codeword, recombines the beams into the optical signal, and decodes the digital data from a wavelength of the optical signal using the codeword.
